(19) United States
(12) Patent Application Publication
(10) Pub. No.: US 2026/0097969 A1
(43) Pub. Date: Apr. 9, 2026

(54) OXIDE MATERIAL AND METHOD FOR PRODUCING THE SAME

(71) Applicants: Murata Manufacturing Co., Ltd., Nagaokakyo-shi (JP); Drexel University, Philadelphia, PA (US)

(72) Inventors: Takayuki KONO, Nagaokakyo-shi (JP); Hiroyuki MORITA, Nagaokakyo-shi (JP); Yasunori HIOKI, Nagaokakyo-shi (JP); Takechi TORITA, Nagaokakyo-shi (JP); Michel BARSOUM, Moorestown, NJ (US); Hussein BADR, Philadelphia, PA (US)

(21) Appl. No.: 19/415,977

(22) Filed: Dec. 11, 2025

Related U.S. Application Data
(63) Continuation of application No. PCT/JP2024/021182, filed on Jun. 11, 2024.
(60) Provisional application No. 63/472,695, filed on Jun. 13, 2023.

(51) Int. Cl. C01G 23/04

(52) U.S. Cl. CPC C01G 23/04; C01P 2002/72; C01P 2002/82; C01P 2004/03; C01P 2004/04; C01P 2006/12; C01P 2006/14

(57) ABSTRACT

An oxide material comprising: one or more selected from the group consisting of a nanofiber, a two-dimensional substance, or an amorphous substance of a material represented by: MQₐO_{b} wherein M is one or more elements selected from the group consisting of Groups 3, 4, 5, 6, and 7, Q is one or more elements selected from the group consisting of Groups 12, 13, 14, 15, and 16, and excluding O, a is 0 to 2, and b is more than 0 and 2 or less, wherein in a Raman spectrum, an average intensity of the oxide material at 745 to 765 cm⁻¹ is smaller than an average intensity at 735 to 745 cm⁻¹, and wherein a pore volume of the oxide material is 0.060 cc/g or more.

### CROSS REFERENCE TO RELATED APPLICATIONS

The present application is a continuation of International application No. PCT/JP2024/021182, filed Jun. 11, 2024, which claims priority to U.S. Provisional Patent Application No. 63/472,695, filed Jun. 13, 2023, the entire contents of each of which are incorporated herein by reference.

### TECHNICAL FIELD

The present disclosure relates to an oxide material and a method for producing the same.

### BACKGROUND ART

In the related art, for example, TiO₂ has been known as an oxide containing metal. Non-Patent Document 1 proposes a method for converting 12 types of Ti including harmless precursors (TiC, TiN, and the like) abundantly present on earth into TiO₂-based one-dimensional (1D) nanofilaments (NFs). It has also been shown that the TiO₂-based one-dimensional (1D) nanofilaments (NFs) can be applied in fields such as photocatalysis, dye decomposition, batteries, and supercapacitors.
Hussein O. Badr et al., “On the structure of one-dimensional TiO₂ lepidocrocite” Matter 6, 128-141, Jan. 4, 2023

### SUMMARY OF THE DISCLOSURE

Materials that exhibit better properties than known TiO₂ are desired. An object of the present disclosure is to provide a novel oxide material exhibiting better properties than TiO₂ and a method for producing the same.

According to one aspect of the present disclosure, there is provided an oxide material comprising: one or more selected from the group consisting of a nanofiber, a two-dimensional substance, or an amorphous substance of a material represented by: MQₐO_{b} wherein M is one or more elements selected from the group consisting of Groups 3, 4, 5, 6, and 7, Q is one or more elements selected from the group consisting of Groups 12, 13, 14, 15, and 16, and excluding O, a is 0 to 2, and b is more than 0 and 2 or less, wherein in a Raman spectrum, an average intensity of the oxide material at 745 to 765 cm⁻¹ is smaller than an average intensity at 735 to 745 cm⁻¹, and wherein a pore volume of the oxide material is 0.060 cc/g or more.

According to another aspect of the present disclosure, there is provided a method for producing an oxide material, the method comprising: (a) preparing a precursor material represented by: MQₐO_{b} wherein M is one or more elements selected from the group consisting of Groups 3, 4, 5, 6, and 7, Q is one or more elements selected from the group consisting of Groups 12, 13, 14, 15, and 16, and excluding O, a is 0 to 2, and b is more than 0 and 2 or less; and (b) performing acid washing of the precursor material using an acid aqueous solution, and then performing water washing.

According to the present disclosure, a novel oxide material exhibiting properties superior to those of TiO₂ and a method for producing the same are provided.

### BRIEF DESCRIPTION OF DRAWINGS

FIG. 1 is a Raman spectroscopic analysis result using dry powder of Example 1.

FIG. 2 is a measurement result of an adsorption isotherm of nitrogen gas using the dry powder of Example 1.

FIG. 3 is a Raman spectroscopic analysis result using dry powder of Comparative Example 1.

FIG. 4 is a measurement result of an XRD profile using dry powder of Comparative Example 1.

FIG. 5 is an explanatory view relating to a crystal axis.

FIG. 6 is a measurement result of an adsorption isotherm of nitrogen gas using the dry powder of Comparative Example 1.

FIG. 7 is a Raman spectroscopic analysis result using dry powder of Comparative Example 2.

FIG. 8 is a measurement result of an XRD profile using dry powder of Comparative Example 2.

FIG. 9 is a measurement result of an adsorption isotherm of nitrogen gas using the dry powder of Comparative Example 2.

FIG. 10 is a Raman spectroscopic analysis result using dry powder of Example 2.

FIG. 11 is a measurement result of an adsorption isotherm of nitrogen gas using the dry powder of Example 2.

FIG. 12 is a Raman spectroscopic analysis result using dry powder of Example 3.

FIG. 13 is a measurement result of an adsorption isotherm of nitrogen gas using the dry powder of Example 3.

FIG. 14 is a Raman spectroscopic analysis result using dry powder of Example 4.

FIG. 15 is a measurement result of an XRD profile using dry powder of Example 4.

FIG. 16 is a SEM observation photograph of a dry powder of Example 4.

FIG. 17 is a measurement result of an adsorption isotherm of nitrogen gas using the dry powder of Example 4.

FIG. 18 is a Raman spectroscopic analysis result using dry powder of Example 5.

FIG. 19 is a measurement result of an XRD profile using dry powder of Example

5.

FIG. 20 is a TEM observation photograph of a dry powder of Example 5.

FIG. 21 is a measurement result of an adsorption isotherm of nitrogen gas using the dry powder of Example 5.

FIG. 22 is a Raman spectroscopic analysis result using dry powder of Example 6.

FIG. 23 is a measurement result of an XRD profile using dry powder of Example

6.

FIG. 24 is a measurement result of an adsorption isotherm of nitrogen gas using the dry powder of Example 6.

FIG. 25 is a Raman spectroscopic analysis result using dry powder of Example 7.

### DESCRIPTION OF THE PREFERRED EMBODIMENTS

### First Embodiment: Oxide Material

The present embodiment relates to an oxide material comprising one or more selected from the group consisting of a nanofiber, a two-dimensional substance, or an amorphous substance in a predetermined material, and in the Raman spectrum, an average intensity at 745 to 765 cm⁻¹ is smaller than an average intensity at 735 to 745 cm⁻¹, and a pore volume is 0.060 cc/g or more.

In the present disclosure, when simply referred to as a “material”, it is intended to mean a predetermined MQₐO_{b} that forms a nanofiber, a two-dimensional substance, and an amorphous substance. In the present embodiment, one or more selected from the group consisting of the nanofiber, the two-dimensional substance, or the amorphous substance typically means a material that is a solid content and does not contain a binder or the like (for example, a polymer).

The oxide material according to the present embodiment may include one or more selected from the group consisting of the nanofiber of the above materials, the two-dimensional substance of the above materials, or the amorphous substance of the above materials (these may be collectively referred to as “MQO particles”). As one possible aspect of the oxide material, for example, the oxide material is substantially composed of one or more selected from the group consisting of a nanofiber of the above materials, a two-dimensional substance of the above materials, or an amorphous substance of the above materials (the oxide material may contain other objects, impurities, and the like that can be inevitably mixed). However, the oxide material according to the present embodiment is not limited thereto.

The oxide material of the present embodiment includes one or more selected from the group consisting of a nanofiber of a predetermined material, a two-dimensional substance of a predetermined material, or an amorphous substance of a predetermined material. The predetermined material that can be used in the present embodiment is represented by the following Formula (1).

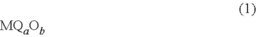

(wherein M is one or more elements selected from the group consisting of Groups 3, 4, 5, 6, and 7, and may contain a so-called early transition metal, for example, one or more elements selected from the group consisting of Sc, Ti, Zr, Hf, V, Nb, Ta, Cr, Mo, and Mn, and preferably one or more elements selected from the group consisting of Ti, V, Cr, Mo, and Mn,
Q is one or more elements (here, O is excluded) selected from the group consisting of Groups 12, 13, 14, 15, and 16, and may contain, for example, a one or more elements selected from the group consisting of B, C, N, Si, P, and S,
a is 0 to 2, and
b is more than 0 and 2 or less)

Hereinafter, the predetermined material is also simply referred to as “MQO”. Examples of MQO include those represented by formulas such as TiO₂, TiCO, TiCON, VO₂, VCO, VCON, CrO₂, CrCO, CrCON, MoO₂, MoCO, MoCON, MnO₂, MnCO, and MnCON. For example, in Formula (1), the M may be Ti, and the Q may be C. Further, for example, in Formula (1), the a may not be 0.

MQO has a crystal structure different from that of a hexagonal system. Although the present embodiment is not bound by any theory, it can be considered that the crystal structure of MQO is an anatase type, a lepidocrocite type, or a mixture thereof at present. For example, the crystal structure of MQO may be a lepidocrocite type.

In the oxide material of the present embodiment, the shape of MQO may be a nanofiber, a two-dimensional substance, or an amorphous substance. MQO is a solid content.

In the present disclosure, the cross-sectional outer dimension of the nanofiber of MQO means the shortest distance passing through the center in the cross section crossing the longitudinal direction of the nanofiber of MQO. The shape of the cross section of the nanofiber of MQO is not particularly limited, but can be approximated by, for example, a rectangle (rectangles, squares, and the like) or an ellipse (flat circle, true circle, and the like). When the nanofiber of MQO is in the form of nanoribbons, the shape of the cross section thereof can be approximated by a rectangle, and the cross-sectional outer dimension can correspond to the short side length of the rectangle. When the nanofiber of MQO is in the form of nanofilaments, the shape of the cross section thereof can be approximated by a flat circle, and the cross-sectional outer dimension can correspond to the short diameter length of the flat circle.

The nanofiber may also be referred to as a nanowire. In the present disclosure, the “nanofiber” means a solid material extending in the longitudinal direction, and the external dimensions of a cross section perpendicular to the longitudinal direction (cross-sectional external dimensions) are nano-order (that is, 1 nm or more and less than 1000 nm) or smaller sub-nano order (less than 1 nm, for example, 0.1 nm or more and less than 1 nm). The longitudinal length of the nanofiber is not limited to the nano-order (that is, 1 nm or more and less than 1000 nm), and may be in the micron order (1 μm or more and less than 1000 μm). The cross-sectional outer dimension of the nanofiber may be, for example, 0.1 nm or more, particularly 1 nm or more, and may be, for example, 100 nm or less, particularly 50 nm or less, preferably 15 nm or less.

In the present disclosure, the two-dimensional substance of MQO includes one or more of nanoflakes and a laminate of nanoflakes.

In the present disclosure, a “two-dimensional substance” means a solid material having a two-dimensionally extended surface (also referred to as a plane or a two-dimensional sheet surface) and having a thickness relatively small with respect to a maximum dimension of the surface (which may correspond to an “in-plane dimension” of a particle), and the thickness is nano-order (that is, 1 nm or more and less than 1000 nm) or smaller sub-nano order (less than 1 nm, for example, 0.1 nm or more and less than 1 nm). The in-plane dimension is not limited to the nano-order (that is, 1 nm or more and less than 1000 nm), and may be in the micron order (1 μm or more and less than 1000 μm). The two-dimensional substance includes one or more of nanoflake and a laminate of nanoflakes. In the present embodiment, the two-dimensional substance is not limited to only the nanoflake and the laminate of nanoflakes. The nanoflake may also be referred to as nanosheets or two-dimensional (nano) sheets. The thickness of one layer of nanoflake may be, for example, 0.01 nm or more, in particular 0.8 nm or more and, for example, 20 nm or less, in particular 3 nm or less. The in-plane dimension of the nanoflake may be, for example, 0.1 μm or more, particularly 1 μm or more, and may be, for example, 200 μm or less, particularly 40 μm or less. The nanoflakes can be constituted by aggregation of nanofibers.

The laminate of nanoflakes may also be referred to as a multi-layer MQO. The distance (interlayer distance or void dimension) between two adjacent nanoflakes (or MQO of two adjacent layers) is not particularly limited.

The oxide material of the present embodiment may contain an amorphous substance of MQO. The amorphous substance of MQO can be confirmed, for example, by a difference from an observed crystal portion of a lattice line in a TEM image shown in Examples described later, and can be confirmed, for example, by an electron diffraction pattern obtained by electron diffraction analysis.

The oxide material of the present embodiment may also include a nanoparticle as the shape of MQO. That is, in the oxide material of the present embodiment, a nanoparticle of a predetermined material may be contained in one or more selected from the group consisting of a nanofiber of a predetermined material, a two-dimensional substance of a predetermined material, or an amorphous substance of a predetermined material. The nanoparticle may be, for example, 0.01 nm or more, in particular 0.1 nm or more, further 1 nm or more, and/or may be, for example, less than 1000 nm, in particular 100 nm or less, or further 50 nm or less.

It should be noted that the dimensions described above may be determined as number average dimensions (for example, number average of at least 40) based on photographs of a scanning electron microscope (SEM), a transmission electron microscope (TEM), or an atomic force microscope (AFM) (if necessary, processing is performed by a method such as a focused ion beam (FIB)), or as distances in the real space calculated from the positions on the reciprocal lattice space of the (002) plane measured by an X-ray diffraction (XRD) method.

The oxide material of the present embodiment may be a porous particle made of the nanofiber. However, it should be noted that in the present disclosure, the MQO is not limited to the above-described form, and may have any suitable form.

As a novel material, a Titanium carbo oxide (hereinafter, referred to as TiCO) wire or flake which is a two-dimensional substance has been proposed. However, conventional TiCO wires or flakes, which are two-dimensional substances, do not have sufficient adsorption performance when used, for example, as an adsorbent. As a result of examining the cause, the present inventors have found that in conventional TiCO wires or flakes which are two-dimensional substances, tetra methyl ammonium (TMA) cations and excess tetra methyl ammonium hydroxide (TMAH) are present on the surface/between layers, and at least one of the pore volume and the specific surface area is reduced due to the presence of these cations, which is considered as the cause.

The oxide material according to the present embodiment is substantially free of TMA cations and TMAH, unlike conventional TiCO wires, flakes that are two-dimensional substances, or the like. The phrase the oxide material according to the present embodiment is “substantially free of TMA cations and TMAH” means that the oxide material does not have a peak in the range of 745 to 765 cm⁻¹ (for example, a peak at the position of about 755 cm⁻¹) attributed to the TMA cations and TMAH when Raman spectroscopic analysis of the oxide material is performed as described in Examples described later. The phrase “does not have a peak in the range of 745 to 765 cm⁻¹” means that an average intensity at 745 to 765 cm⁻¹ is smaller than an average intensity at 735 to 745 cm⁻¹ in the Raman spectrum. The average intensity at 745 to 765 cm⁻¹ is determined as the average value of the intensity at 745 cm⁻¹ and the intensity at 765 cm⁻¹, and the average intensity at 735 to 745 cm⁻¹ is determined as the average value of the intensity at 735 cm⁻¹ and the intensity at 745 cm⁻¹.

The oxide material of the present embodiment substantially free of the TMA cations and TMAH can be realized, for example, by performing acid washing in the production step thereof as described later.

The oxide material of the present embodiment has a pore volume of 0.060 cc/g or more. The pore volume refers to a pore volume calculated from the DFT theory as shown in Examples described later. The pore volume may be further 0.150 cc/g or more.

The oxide material of the present embodiment preferably has a large specific surface area. More specifically, the specific surface area (BET specific surface area) calculated by the BET method may be 130 m²/g or more. The BET specific surface area is calculated using the BET equation from an isothermal adsorption curve of nitrogen gas or other gases under liquid nitrogen temperature (77 K) by an adsorption method with nitrogen gas or other suitable gases such as krypton (Kr) gas. The upper limit is not particularly limited, but may be, for example, 800 m²/g or less. In order to obtain a larger specific surface area, the freeze dry is preferably performed. That is, as one form of the oxide material of the present embodiment, a freeze-dried powder can be mentioned.

The oxide material of the present embodiment may have a protonated surface.

In the oxide material of the present embodiment, preferably, MQO does not contain elements of Groups 3, 4, 5, 6, and 7 other than the elements constituting M, and other metal elements. For example, when the element constituting M of MQO is Ti, it is indicated that elements of Groups 3, 4, 5, 6, and 7 other than Ti and other metal elements are not contained, and for example, it is indicated that metal ions other than Ti are not contained. The absence of elements of Groups 3, 4, 5, 6, and 7 and other metal elements other than the elements constituting M can be confirmed by ICP-AES using inductively coupled plasma atomic emission spectrometry. As the “does not contain elements of Groups 3, 4, 5, 6, and 7 other than the elements constituting M, and other metal elements”, the content of the “elements of Groups 3, 4, 5, 6, and 7 other than the elements constituting M, and other metal elements” measured by ICP-AES using inductively coupled plasma emission spectrometry is a certain amount or less, for example, 0.0100% by mass or less, further 0.0050% by mass or less, and further 0.0020% by mass or less.

### Second Embodiment: Method for Producing Oxide Material

According to the present disclosure, there is provided a method for producing an oxide material, the method comprising:
(a) preparing a precursor material (hereinafter, may be simply referred to as “MQO”) represented by the following formula:

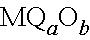

wherein M is one or more elements selected from the group consisting of Groups 3, 4, 5, 6, and 7,
Q is one or more elements (here, O is excluded) selected from the group consisting of Groups 12, 13, 14, 15, and 16,
a is 0 to 2, and
b is more than 0 and 2 or less; and
(b) performing acid washing of the precursor material using an acid aqueous solution, and then performing water washing. Each step will be described below.

### Step (a)

A predetermined precursor material (MQO) is prepared. Production of the precursor material (MQO) is not limited, and can be produced, for example, by the following method.

MQO can be produced using a first raw material and a second raw material, for example, as follows. The first raw material contains at least the M, the second raw material contains at least the Q, and the first raw material and the second raw material can react in a protic solvent to generate MQO.

As the first raw material, a material represented by the following Formula (2) can be used.

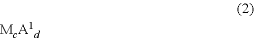

(wherein M is as described above,
A¹ is one or more elements selected from the group consisting of Groups 12, 13, 14, 15, and 16, and may contain, for example, one or more elements selected from the group consisting of B, C, N, O, Si, P, and S, and
c and d are each independently 1 to 5)

However, the material represented by Formula (2) needs to be different from the MQO of the product. Typically, the material represented by Formula (2) may not have a peak in a range in which a diffraction angle 2θ is 2° to 12° in an X-ray diffraction (XRD) pattern.

Examples of the first raw material represented by Formula (2) include TiB₂, TiB, TiC, TIN, TiO₂, Ti₅Si₃, Ti₂SbP, VO₂, V₂O₄, NbC, Nb₂O₅, MoO₂, MoO₃, MoS₂, MnO₂, Mn₃O₄, and MnCO₃. MnO₂ that can be used as the first raw material has a peak in the vicinity of 2θ=13° and does not have a peak in the range where 2θ is 2° to 12° in the XRD pattern.

Alternatively, or in addition to the above, a material represented by the following Formula (3) (hereinafter, also simply referred to as “MAX phase” or “MAX raw material”) can be used as the first raw material.

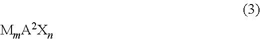

(wherein M is as described above,
X is one or more elements selected from the group consisting of C and N,
n is 1 to 4,
m is more than n and 5 or less,
A² is one or more elements selected from the group consisting of Groups 12, 13, 14, 15, and 16, is usually a Group A element, typically Group IIIA and Group IVA, and more particularly may include one or more selected from the group consisting of Al, Ga, In, Tl, Si, Ge, Sn, Pb, P, As, S, and Cd, and is preferably Al)

The MAX phase has a crystal structure in which a layer constituted by A² atoms is positioned between two layers represented by MₘXₙ (each X may have a crystal lattice positioned in an octahedral array of M). When typically m=n+1, the MAX phase includes repeating units in which each one layer of X atoms is disposed in between adjacent layers of n+1 layers of M atoms (these are also collectively referred to as an “MₘXₙ layer”), and a layer of A² atoms (“A² atom layer”) is disposed as a layer next to the (n+1)th layer of M atoms. However, the MAX phase is not limited thereto.

Examples of the first raw material represented by Formula (3) include Ti₃AlC₂, Ti₃GaC₂, and Ti₃SiC₂.

As the first raw material, the material represented by Formula (2) and the material represented by Formula (3) may be used together (for example, as a mixture).

As the second raw material, an ion-binding substance having a carbon-containing group can be used. The ion-binding substance having a carbon-containing group contains C. Examples of the ion-binding substance include ammonium salts, phosphate salts, and sulfate salts.

More specifically, a quaternary ammonium salt can be used as the second raw material. Examples of the quaternary ammonium salts include tetramethylammonium hydroxide (TMAH), tetraethylammonium hydroxide (TEAH), tetrapropylammonium hydroxide (TPAH), tetrabutylammonium hydroxide (TBAH or TBAOH), benzyltrimethylammonium hydroxide, tetrabutylammonium fluoride (TBAF), tetrabutylammonium chloride (TBACI), tetrabutylammonium bromide (TBAB), tetrabutylammonium iodide (TBAI), benzyltriethylammonium chloride (BTEAC), hexadecyltrimethylammonium bromide, cetyltrimethylammonium bromide (CTAB), benzetonium chloride, benzalkonium chloride, and cetylpyridinium chloride (CPC). Among them, TMAH and TBAOH are preferable.

Alternatively, or in addition to the above, other ion-binding substances containing P and/or S or the like may be used as the second raw material.

The protic solvent may be any solvent that can at least partially dissolve the first raw material and the second raw material, and may be particularly an aqueous solvent. As the protic solvent, water, an alcohol (for example, ethanol, 1-propanol, and isopropanol), a carboxylic acid (for example, acetic acid and formic acid), or the like is used. The aqueous solvent may consist of water and optionally a liquid substance compatible with water (for example, a protic solvent other than water), preferably water.

The first raw material and the second raw material are reacted in the protic solvent. The second raw material can be added to the protic solvent in advance. The proportion of the second raw material to the total of the protic solvent and the second raw material may be, for example, 5% by mass or more, particularly 20% by mass or more, and/or may be, for example, 80% by mass or less, particularly 50% by mass or less. The first raw material can be further added to and mixed with the protic solvent to which the second raw material has been added. In such a mixture, a reaction for generating MQO proceeds. The temperature (reaction temperature) of the mixture (which may include the reaction product) may be, for example, 15° C. or higher, in particular 40° C. or higher, and/or, for example, 100° C. or lower, in particular 80° C. or lower. The mixing time (reaction time) may, for example, be 1 day or more, in particular 2 days or more, and/or may, for example, 10 days or less, in particular 7 days or less. The mixing can be performed, for example, by rotating and stirring with a magnetic stirrer charged into the container while maintaining the reaction temperature by a hot plate stirrer and a hot water bath. However, the treatment operation and conditions (temperature, time, and the like) under which the reaction can proceed are not limited to the above, and may be appropriately selected according to the first raw material, the second raw material, the protic solvent, and the like to be used.

By the above reaction, MQO is generated, and can eventually grow into a nanofiber of MQO, and further into nanoflake of MQO. Without limiting the present disclosure, the obtained nanofiber of the MQO may be in the form of nanoribbons extending at nanoscale widths. In addition, a plurality of nanofibers (for example, nanoribbons) of MQOs may be bonded and/or integrated with each other to grow into nanoflakes extending two-dimensionally. In addition, a plurality of MQO nanoflakes may overlap each other (for example, by van der Waals force) to form a laminate. Although the present disclosure is not bound by any theory, the generation and growth of such MQO can be considered to be due to a bottom-up type synthesis reaction.

After the above reaction, a separation operation (centrifugation and/or decantation) may be performed after washing using a protic solvent. The washing and separation operations may be repeated until the pH of a supernatant after centrifugation is, for example, 8 or less. The same description as above may apply to the protic solvent, and the protic solvent may be, for example, water or alcohol. For example, it may be washed with alcohols such as ethanol, and a separation operation (centrifugation and/or decantation) may be performed. Washing and separation operations are repeatedly performed until the pH of the supernatant after centrifugation becomes, for example, 8 or less, and then water washing is further performed to obtain a slurry to be subjected to the acid washing.

Optionally, washing may be performed using an aqueous solution of a metal salt instead of or in addition to the above washing. The metal salt may be, for example, a halide (fluoride, chloride, bromide, iodide) of an alkali metal (Li, Na, K, and the like), typically LiCl, NaCl, KCl, or the like. Specifically, for example, washing may be performed using a metal salt aqueous solution having a molar concentration of 1 to 10. After washing, a separation operation (centrifugation and/or decantation) may be carried out. Also in this case, washing and separation operations may be repeated as necessary until the pH of the supernatant after centrifugation is, for example, 8 or less.

The precursor material obtained in step (a) is a material containing at least one of TMA cations and TMAH, and having an average intensity at 745 to 765 cm⁻¹ larger than an average intensity at 735 to 745 cm⁻¹ in the Raman spectrum.

### Step (b)

The precursor material is acid-washed using an acid aqueous solution, and then water-washed.

The acid used for the production of the acid aqueous solution is not limited, and for example, organic acid and/or inorganic acid such as mineral acid can be used. As the organic acid, for example, one or more of acetic acid, citric acid, oxalic acid, benzoic acid, sorbic acid, and the like can be used. As the inorganic acid, for example, one or more of hydrochloric acid, sulfuric acid, nitric acid, phosphoric acid, perchloric acid, hydroiodic acid, hydrobromic acid, hydrofluoric acid, and the like can be used. It is preferably one or more of acetic acid, nitric acid, and sulfuric acid. The concentration of the acid in the acid aqueous solution to be mixed with the precursor material may be adjusted according to the amount, concentration, and the like of the precursor material to be treated. The concentration of the acid in the acid aqueous solution can be, for example, 0.01 M to 10 M, and further can be 5 M or less.

In the acid washing, the precursor material and the acid solution come into contact with each other, and the TMA cation and the TMAH contained in the precursor material are removed. By performing the acid washing in this manner, the TMA cations and TMAH contained in the precursor material are removed, and the obtained oxide material is substantially free of the TMA cations and TMAH. By this acid washing, it is possible to obtain an oxide material in which the average intensity at 745 to 765 cm⁻¹ is smaller than the average intensity at 735 to 745 cm⁻¹ and the pore volume is 0.060 cc/g or more in the Raman spectrum. As a method for bringing the precursor material into contact with the acid solution, bringing the aqueous dispersion of the precursor material into contact with the acid aqueous solution, for example, mixing the aqueous dispersion of the precursor material with the acid aqueous solution and, for example, stirring the mixture can be mentioned as one aspect. The aqueous dispersion may be a slurry obtained in the step of producing the precursor material, or may be obtained by dispersing the solid content of the precursor material in water. Another aspect of the method for bringing the precursor material into contact with the acid solution includes bringing the precursor material that is a solid into contact with the acid aqueous solution, for example, immersing the precursor material in the acid aqueous solution, and stirring the precursor material as necessary. Examples of the stirring method include stirring using a handshake, an automatic shaker, a share mixer, a pot mill, or the like. The degree of stirring such as stirring speed and stirring time may be adjusted according to the amount, concentration, and the like of the etched product which is an object to be treated.

When the acid aqueous solution is mixed and stirred, heating may or may not be performed. The acid aqueous solution may be mixed and stirred without being heated, or may be stirred while being heated in a range in which the liquid temperature is 80° C. or lower.

After performing the acid washing, water washing is performed. The acid-washed product obtained by the acid washing is water-washed to adjust the pH after the acid washing. For example, the pH of an acidic region is set to, for example, about 5 to 8.

The time between the acid washing and the water washing can be appropriately selected according to a desired crystal structure. For example, as shown in Examples described later, when the contact time with the acid aqueous solution is short, a lepidocrocite type crystal structure tends to be formed, and when the contact time is long, an anatase type crystal structure tends to be formed.

The production method of the present embodiment includes the step (a) and the step (b), and the other steps are not limited. As described below, the following post-treatment step may be included after step (b).

The water-washed product obtained by the water washing may be appropriately subjected to post-treatment. Examples of the post-treatment include drying (for example, freeze dry, heat dry), impact application (including shear force application), and pulverization. For example, the dispersion of the MQO particles (for example, nanofibers/nanoflakes, the same applies to the following) and the like can be promoted by applying an impact such as vibration and/or ultrasonic waves. When the MQO particles are aggregated, an aggregate can be crushed. The impact can be imparted using, for example, any one or more of a handshake, an automatic shaker, a mechanical shaker, a vortex mixer, a homogenizer, an ultrasonic bath, and the like.

Since the MQO particles are solid contents, the separation operation may be performed at any suitable time to remove unwanted liquid components, if present. As a final separation operation, for example, a drying operation, typically freeze dry or heat dry, may be performed. The freeze dry may be performed, for example, by freezing a mixture containing the MQO particles and a liquid component at any suitable temperature (for example, −40° C.), followed by drying under reduced pressure atmosphere. The heat dry can be performed, for example, by drying a mixture containing the MQO particles and a liquid component at a temperature of 25° C. or higher (for example, 200° C. or lower) under a normal pressure or a reduced pressure atmosphere. The pulverization is not particularly limited, but can be performed using, for example, a combination of a mortar and a pestle, an IKA mill, or the like. The pulverization may be performed after drying.

As described above, the oxide material (oxide material containing MQO) according to the present embodiment can be obtained. Although MQO is represented by Formula (1), the oxide material (typically, MQO particles) according to the present embodiment does not need to be composed of only the constituent elements of Formula (1). Although the present disclosure is not limited, the oxide material according to the present embodiment may optionally have one or more selected from the group consisting of a hydroxyl group, a chlorine atom, an oxygen atom, a hydrogen atom, or a nitrogen atom as a modifier/terminal T present on the surface thereof.

According to the study of the present inventors, it has been found that the oxide material according to the present embodiment can adsorb a large amount of nitrogen or the like. The oxide material of the present embodiment includes one or more selected from the group consisting of a nanofiber, a two-dimensional substance, or an amorphous substance of a predetermined material (as one aspect, including one or more selected from the group consisting of a nanofiber, a two-dimensional substance, or an amorphous substance of a predetermined material), has an average intensity of 745 to 765 cm⁻¹ smaller than an average intensity of 735 to 745 cm⁻¹ in the Raman spectrum, and has a certain pore volume or more, and thus has an ability to adsorb nitrogen or the like.

Typically, the oxide material according to the present embodiment may have a peak in a diffraction angle 2θ in a range of 2° or higher and 12° or lower in an X-ray diffraction (XRD) pattern. Although the present disclosure is not bound by any theory, it is considered that the fact that the oxide material according to the present embodiment has a peak in the range of 20-2° or higher and 12° or lower in the XRD pattern means that the MQO has a crystal structure different from that of a well-known metal oxide. In addition, as measured in Examples described later, it can be confirmed that MQO has a crystal structure of lepidocrocite by having peaks at 2θ=26°, 2θ=48°, and 2θ=63°. Furthermore, by having peaks at 2θ=26° and 2θ=38°, 2θ=48°, and 2θ=54° and 2θ=63°, it can be confirmed that MQO has an anatase type crystal structure. Furthermore, as measured in Examples described later, the presence or absence of TMA cations between layers can also be supplementarily confirmed by the size of d spacing obtained from the peak in the range of 2θ=2° to 12°.

In the present disclosure, an XRD pattern is a pattern (the vertical axis represents intensity, and the horizontal axis represents 2θ) obtained by θ-axis direction scanning with an XRD analyzer using CuKα rays (=about 1.54 angstroms) as characteristic X-rays, and may also be referred to as an “XRD profile”. The peaks in the XRD pattern can be identified visually or using the software used with the XRD analyzer.

Although the present embodiment is not limited, for example, in the oxide material of the present embodiment (more specifically, MQO), a Raman shift may have peaks at positions of at least 275 to 295 cm⁻¹, 435 to 455 cm⁻¹, and 665 to 745 cm⁻¹ in the Raman spectrum using a laser with a wavelength of 514 nm.

Although the present embodiment is not limited, for example, in the oxide material of the present embodiment (more specifically, MQO), a Raman shift may have peaks at positions of 140 to 160 cm⁻¹, 275 to 295 cm⁻¹, 435 to 455 cm⁻¹, and 665 to 745 cm⁻¹ in the Raman spectrum using a laser with a wavelength of 514 nm. Incidentally, 140 to 160 cm⁻¹ is an anatase type peak.

Although the present embodiment is not limited, for example, the oxide material of the present embodiment (more specifically, MQO) has a crystal structure of an anatase type, a lepidocrocite type, or a mixture thereof. More preferably, it has a lepidocrocite type crystal structure.

Although the present embodiment is not limited, for example, the oxide material of the present embodiment (more specifically, MQO) can take an aspect in which a Raman shift has peaks at positions of at least 275 to 295 cm⁻¹, 435 to 455 cm⁻¹, and 665 to 745 cm⁻¹ in a Raman spectrum using a laser with a wavelength of 514 nm, and X is the largest when the intensity of each peak is X, Y, and Z.

Although the present embodiment is not limited, more preferably, the oxide material of the present embodiment (more specifically, MQO) can take an aspect in which a Raman shift has peaks at positions of at least 180 to 200 cm⁻¹, 275 to 295 cm⁻¹, 375 to 395 cm⁻¹, 435 to 455 cm⁻¹, and 665 to 745 cm⁻¹ in a Raman spectrum using a laser with a wavelength of 514 nm, and X is the largest when the intensity of each peak is V, X, Y, Z, and W.

In the present disclosure, the Raman spectrum is measured by a Raman spectrometer using a laser beam having a wavelength of 514 nm as an excitation light source (the vertical axis represents intensity, and the horizontal axis represents Raman shift). The peaks in the Raman spectrum can be identified visually or using the software used with the Raman spectrometer.

In addition, the oxide material of the present embodiment may contain unreacted first raw material and/or second raw material as impurities, and may contain a substance derived from the first raw material, the second raw material, and/or the protic solvent. For example, when a quaternary ammonium salt is used as the second raw material, N may exist (remain) in any form in the oxide material of the present embodiment. Although the present embodiment is not limited, the oxide material of the present embodiment may contain ammonium ions and tetramethylammonium ions. For example, when the MAX raw material is used as the first raw material, in the present disclosure, the oxide material of the present embodiment may contain a relatively small amount of remaining A atoms, for example, 10% by mass or less with respect to the original A atoms. The remaining amount of A atoms can be preferably 8% by mass or less, and more preferably 6% by mass or less. However, even if the residual amount of A atoms exceeds 10% by mass, there may be no problem depending on use conditions and the like.

### EXAMPLES

Hereinafter, the present disclosure will be described more specifically with reference to Examples. The present disclosure is not limited by the following examples, and can be implemented with appropriate modifications within the scope that can be consistent with the above-described and later-described gist, and any of them is included in the technical scope of the present disclosure.

### Example 1

### Production of Sample Slurry Containing TiCO

First, a container (100 mL Aiboy) was charged with 1 g of titanium diboride (TiB₂, −325 mesh, manufactured by Thermo Scientific) and 10 mL of a 25% by mass of tetramethylammonium hydroxide (TMAH) solution (manufactured by Alfa Aesar). Thereto was placed a stirrer chip having a length substantially equal to the inner diameter of a circular bottom surface of a container (35 mm). While the container was kept at 80° C. in an oil bath, the mixture in the container was stirred with a stirrer chip and maintained for 120 hours, thereby allowing the reaction to proceed.

The reaction mixture in the container was then transferred to a centrifuge tube. Centrifugation was performed using a centrifuge under the condition of 3500 G for 5 minutes to precipitate a solid content. (i) After centrifugation, the supernatant was discarded, (ii) 40 mL of ethanol (manufactured by Fisher Chemical Co., Ltd.) was added to the remaining precipitate in the centrifuge tube, dispersion treatment using a Vortex mixer was performed for 5 minutes (reslurry), and (iii) centrifugation was performed under the same conditions as described above. The operations (i) to (iii) were repeated until the pH of the supernatant was 8 or less. When the procedure was repeated three times, the pH of the supernatant became 8 or less. Therefore, this supernatant was discarded, and the repeated operation was terminated. 40 mL of ion-exchanged water was added to the remaining precipitate in the centrifuge tube, and the mixture was shaken and stirred for 5 minutes using a Vortex mixer. Thereafter, centrifugation was performed using a centrifuge under the condition of 3500 G for 30 minutes, and the supernatant was recovered as a sample slurry. The obtained sample slurry corresponds to a slurry containing TiCO (refer to the following analysis results).

### Production of Acid-Washed Slurry

20 mL of a 0.5 M acetic acid aqueous solution was added to 20 mL of the sample slurry, and the mixture was shaken and stirred for 3 minutes using a Vortex mixer. Within 5 minutes after that, centrifugation was performed using a centrifuge under the condition of 4000 G for 5 minutes to precipitate a solid content. (i) After centrifugation, the supernatant was discarded, (ii) 30 mL of ion-exchanged water was added to the remaining precipitate in the centrifuge tube, dispersion treatment using a Vortex mixer was performed for 5 minutes (reslurry), and (iii) centrifugation was performed under the same conditions as described above. The operations (i) to (iii) were repeated until the pH of the supernatant reached 7 or more, and finally 30 mL of ion-exchanged water was added to obtain an acid-washed slurry. The above operation was performed within 1 hour from the addition of the acid aqueous solution.

### Preparation of Dry Powder

The acid-washed slurry was subjected to a dispersion treatment using a Vortex mixer for 5 minutes, and a poly bottle containing the slurry was immersed in liquid nitrogen and frozen. Subsequently, the frozen sample was dried under a reduced pressure atmosphere for 24 hours to obtain a dry powder.

### Analysis

### (Raman Spectroscopic Analysis)

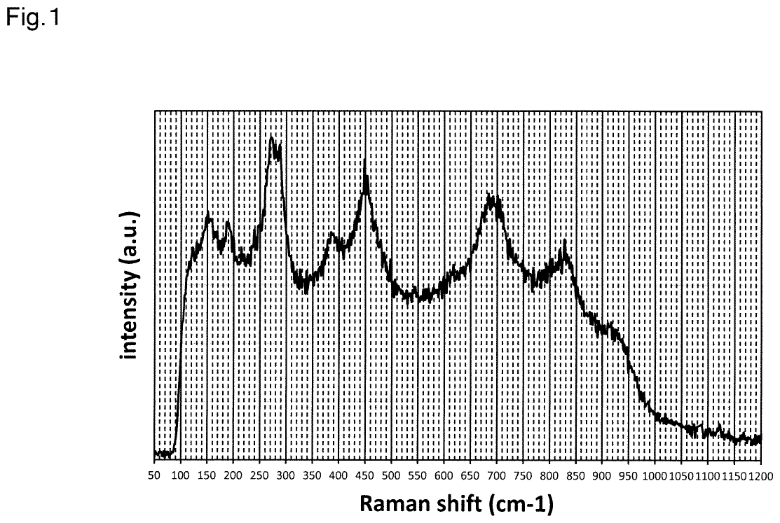

The dry powder obtained in the same manner as described above was subjected to Raman spectroscopic analysis. In the Raman spectroscopic analysis, a Raman shift was obtained using a laser with a wavelength of 514 nm using a Raman microscope (manufactured by RENISHAW K.K., product name: inVia). The result is illustrated in FIG. 1. From FIG. 1, it can be seen that in the Raman spectrum using a laser with a wavelength of 514 nm, the Raman shift has peaks at positions of 190, 270, 285, 385, 450, 700, and 830 cm⁻¹. Since the dried powder has peaks at these positions, it is considered that the dry powder has a lepidocrocite type crystal structure. In addition, since it has a peak at the position of 665 to 745 cm⁻¹ and the average intensity at 745 to 765 cm⁻¹ is smaller than the average intensity at 735 to 745 cm⁻¹, it is considered that TMA cations and TMAH was able to be removed.

### (BET Specific Surface Area)

The dry powder obtained above was subjected to a heat treatment as a degassing treatment at 60° C. for 1 hour, then at 100° C. for 1 hour, and then at 150° C. for 6 hours under reduced pressure. After the degassing treatment, using the obtained dry powder, an adsorption isotherm of nitrogen gas was measured at a liquid nitrogen temperature (77 K). As a result, the BET specific surface area (SSA) of the dry powder was 290 m²/g.

### (Pore Volume (DFT Theory))

The pore volume based on the DFT theory was calculated using the above adsorption isotherm results and found to be 0.336 cc/g.

### (Evaluation of Adsorption Performance)

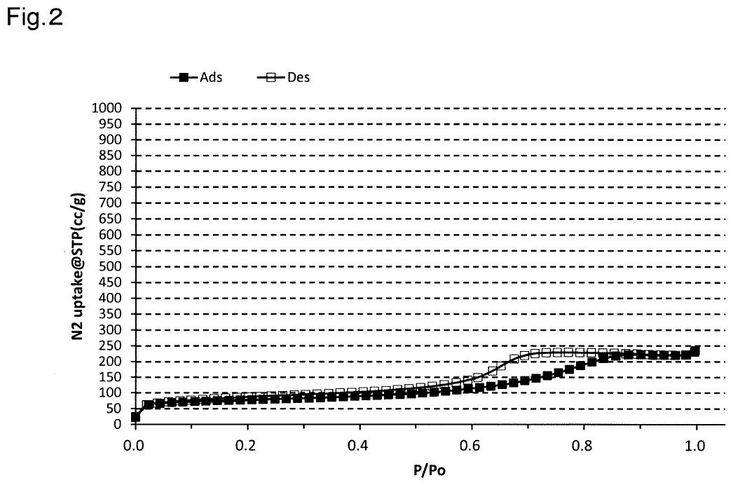

The measurement results of the nitrogen gas adsorption isotherm are illustrated in FIG. 2. “Ads” represents an adsorption process, “Des” represents a desorption process, the horizontal axis represents a relative pressure P/P₀(−) of nitrogen (N₂) gas, and the vertical axis represents the nitrogen adsorption amount (cc/g), which represents the nitrogen gas uptake volume. From the results in FIG. 2, the maximum value of the nitrogen adsorption amount was about 235 cc/g.

### Comparative Example 1

### Production of Sample Slurry Containing TiCO

A sample slurry containing TiCO was produced in the same manner as in Example 1.

### Preparation of Dry Powder

In Comparative Example 1, unlike Example 1, the sample slurry was not acid-washed, and the produced sample slurry was subjected to a dispersion treatment using a Vortex mixer for 5 minutes, and then subjected to suction filtration using a Nutsche overnight. As a filter for suction filtration, a membrane filter (Durapore, manufactured by Merck KGaA, pore size 0.22 μm) was used. After suction filtration, a precursor membrane on the filter was dried overnight at 50° C. in an oven to remove the filter, thereby obtaining a dry powder.

### Analysis

### (Raman Spectroscopic Analysis)

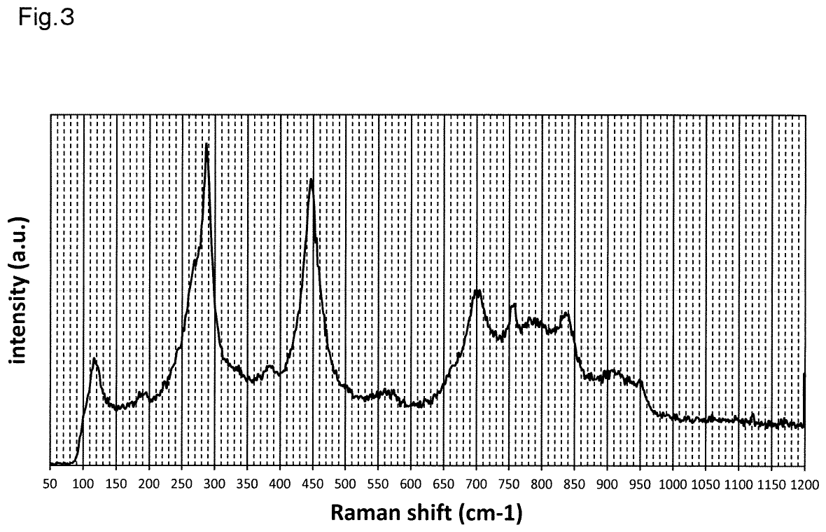

The dry powder obtained in the same manner as described above was subjected to Raman spectroscopic analysis in the same manner as in Example 1, and a Raman shift was obtained using a laser having a wavelength of 514 nm. The result is illustrated in FIG. 3. From FIG. 3, it can be seen that in the Raman spectrum using a laser with a wavelength of 514 nm, the Raman shift has peaks at positions of 195, 285, 385, 445, 700, 755, and 835 cm⁻¹. Since having peaks at these positions, it is considered that the obtained material has a lepidocrocite type crystal structure. In addition, since a peak is present at a position of 755 cm⁻¹, it is considered that TMA cations and TMAH are present.

### (Measurement of XRD Profile)

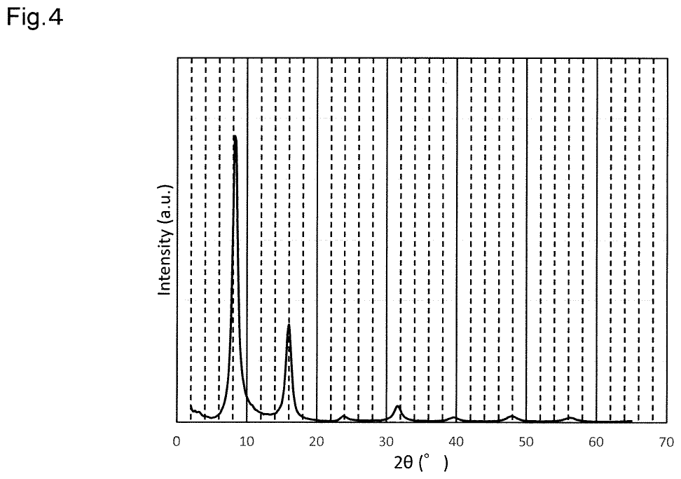

The XRD profile of the dry powder obtained in the same manner as described above was determined. In the measurement of the XRD profile, an XRD apparatus (MiniFlex manufactured by Rigaku Corporation) was used (characteristic X-ray: CuKα=1.54 angstroms). The obtained XRD pattern is shown in FIG. 4. As illustrated in FIG. 4, this material has peaks at 2θ=24° and 2θ=48°. Since it has peaks at these positions, it is considered to have the crystal structure of lepidocrocite.

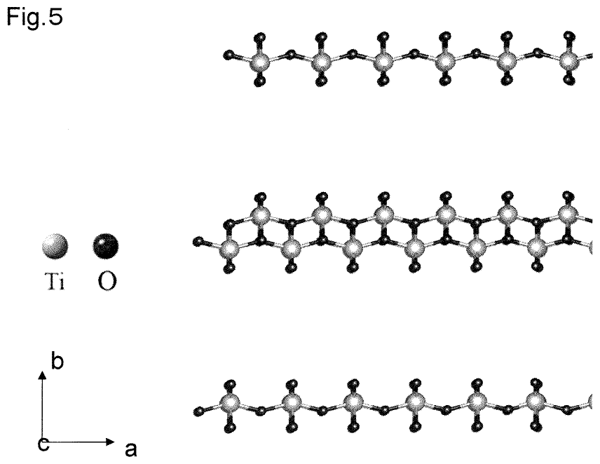

When the crystal axis was determined as illustrated in FIG. 5, peaks of the crystal plane (0k0) were confirmed at 2θ=8°, 16°, 24°, 32°, 39°, 48°, and 56°. This is because the one-dimensional nanofibers arranged in a b-axis direction become a two-dimensional sheet and are stacked in a c-axis direction. The relatively large d-spacing=11 angstroms obtained from 2θ=8° is considered to be due to the presence of TMA cations between the layers.

### (BET Specific Surface Area)

Using the dry powder obtained as described above, degassing treatment was performed in the same manner as in Example 1, and then an adsorption isotherm of nitrogen gas was measured at a liquid nitrogen temperature (77 K). As a result, the BET specific surface area (SSA) of the dry powder was 21 m²/g.

### (Pore Volume (DFT Theory))

The pore volume based on the DFT theory was calculated using the above adsorption isotherm results and found to be 0.018 cc/g.

### (Evaluation of Adsorption Performance)

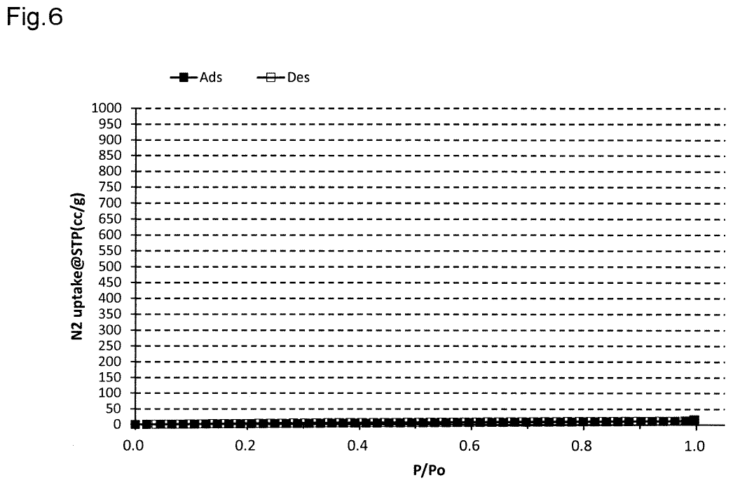

The adsorption isotherm (the description of the adsorption isotherm is the same as in Example 1) obtained by the above measurement is illustrated in FIG. 6. From the results in FIG. 6, the maximum value of the nitrogen adsorption amount was about 17 cc/g.

### Comparative Example 2

### Production of Sample Slurry Containing TiCO

A sample slurry containing TiCO was produced in the same manner as in Comparative Example 1.

### Production of LiCl-Washed TiCO Slurry

20 mL of a 0.5 M LiCl (Alfa Aesar, >99% purity) aqueous solution was added to 20 mL of the sample slurry, and the mixture was shaken and stirred for 3 minutes using a Vortex mixer. Then, centrifugation was performed using a centrifuge under the condition of 4000 G for 5 minutes to precipitate a solid content. (i) After centrifugation, the supernatant was discarded, (ii) 30 mL of ion-exchanged water was added to the remaining precipitate in the centrifuge tube, dispersion treatment using a Vortex mixer was performed for 5 minutes (reslurry), and (iii) centrifugation was performed under the same conditions as described above. The operations (i) to (iii) were repeated 3 times, and finally 30 mL of ion-exchanged water was added to obtain a LiCl-washed TiCO slurry.

### Preparation of Dry Powder

A dry powder was prepared in the same manner as in Comparative Example 1.

### Analysis

### (Raman Spectroscopic Analysis)

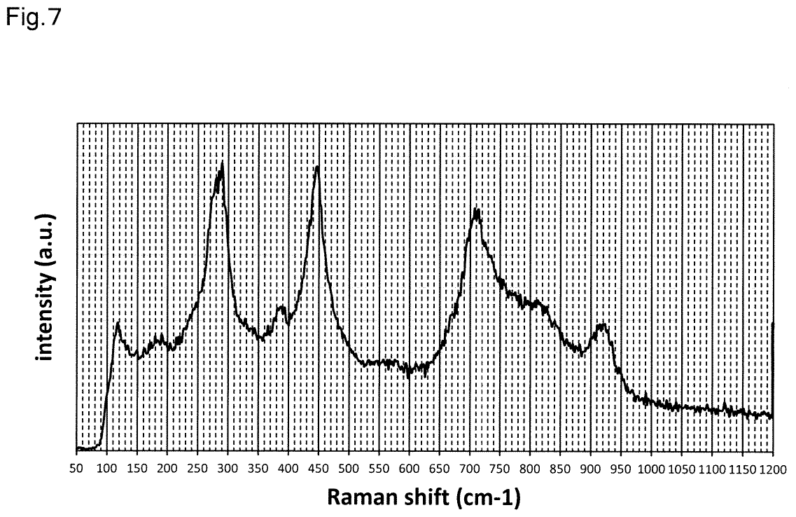

The dry powder obtained in the same manner as described above was subjected to Raman spectroscopic analysis in the same manner as in Example 1, and a Raman shift was obtained using a laser having a wavelength of 514 nm. The result is illustrated in FIG. 7. From FIG. 7, it can be seen that in the Raman spectrum using a laser with a wavelength of 514 nm, the Raman shift has peaks at positions of 190, 290, 385, 445, 710, and 920 cm⁻¹. Since having peaks at these positions, it is considered that the obtained material has a lepidocrocite type crystal structure. In addition, since it has a peak at the position of 665 to 745 cm⁻¹ and the average intensity at 745 to 765 cm⁻¹ is smaller than the average intensity at 735 to 745 cm 1, it is considered that the TMA cations and TMAH derived from the production step have been removed.

### (Measurement of XRD Profile)

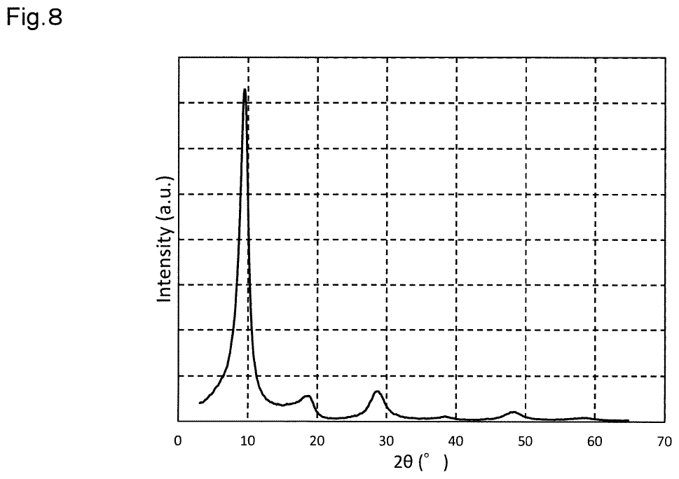

The XRD profile of the dry powder obtained in the same manner as described above was determined in the same manner as in Comparative Example 1. The obtained XRD pattern is illustrated in FIG. 8. As illustrated in FIG. 8, this material has peaks at 2θ=28° and 2θ=48°. Since it has peaks at these positions, it is considered to have the crystal structure of lepidocrocite.

When the crystal axis was determined as illustrated in FIG. 5, peaks of the crystal plane (0k0) were confirmed at 2θ=9°, 19°, 28°, 38°, 48°, and 58°. This is because the one-dimensional nanofibers arranged in a b-axis direction become a two-dimensional sheet and are stacked in a c-axis direction. In addition, d spacing=9 angstroms obtained from 2θ=9° was smaller than that of Comparative Example 1. This is considered to be because the TMA cation present between the layers was replaced with a Li cation.

### (BET Specific Surface Area)

Using the dry powder obtained as described above, degassing treatment was performed in the same manner as in Example 1, and then an adsorption isotherm of nitrogen gas was measured at a liquid nitrogen temperature (77 K). As a result, the BET specific surface area (SSA) of the dry powder was 51 m²/g.

### (Pore Volume (DFT Theory))

The pore volume based on the DFT theory was calculated using the above adsorption isotherm results and found to be 0.057 cc/g.

### (Evaluation of Adsorption Performance)

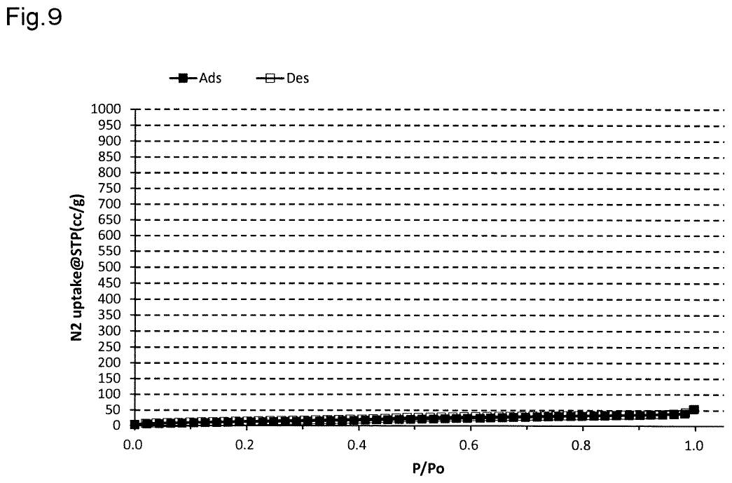

The adsorption isotherm (the description of the adsorption isotherm is the same as in Example 1) obtained by the above measurement is illustrated in FIG. 9. From the results in FIG. 9, the maximum value of the nitrogen adsorption amount was about 54 cc/g.

The following can be said from the comparison between Example 1 and Comparative Examples 1 and 2. In Example 1, the N₂ adsorption amount was increased as compared with Comparative Examples 1 and 2. As a reason therefor, it is considered that the TMA cations/TMAH on the surface/between layers were removed by performing acid washing in the production step, and the pore volume and the specific surface area were thereby increased.

On the other hand, in Comparative Example 1, it is considered that the acid washing was not performed in the production step (that is, the conventional MQₐO_{b} production process), and the presence of the TMA cation/TMAH between the surface and the interlayer decreased the specific surface area and the pore volume, resulting in a decrease in the nitrogen adsorption amount. This is considered to be because the bulky TMA cation/TMAH inhibited the adsorption of nitrogen. In Comparative Example 2, the TMA cation/TMAH on the surface/between the layers was removed, but it is considered that the presence of the Li cation between the layers reduced the specific surface area and the pore volume, and as a result, the nitrogen adsorption amount was reduced. This is considered to be because the Li cation absorbs moisture, and as a result, the pore volume and the like are reduced.

In the following Examples 2 to 7, an aspect in which the producing conditions of Example 1 are changed is shown.

### Example 2

In Example 2, a dry powder was obtained in the same manner as in Example 1 except that the dry powder was prepared by the following method. Specifically, in the preparation of the dry powder, suction filtration using Nutsche and drying by an oven were used instead of freeze drying.

### Production of Sample Slurry Containing TiCO and Production of Acid-Washed Slurry

A sample slurry containing TiCO and an acid-washed slurry were produced in the same manner as in Example 1.

### Preparation of Dry Powder

The obtained acid-washed slurry was subjected to a dispersion treatment using a Vortex mixer for 5 minutes, and subjected to suction filtration using a Nutsche overnight. As a filter for suction filtration, a membrane filter (Durapore, manufactured by Merck KGaA, pore size 0.22 μm) was used. After suction filtration, a precursor membrane on the filter was dried overnight at 50° C. in an oven to remove the filter, thereby obtaining a dry powder.

### Analysis

### (Raman Spectroscopic Analysis)

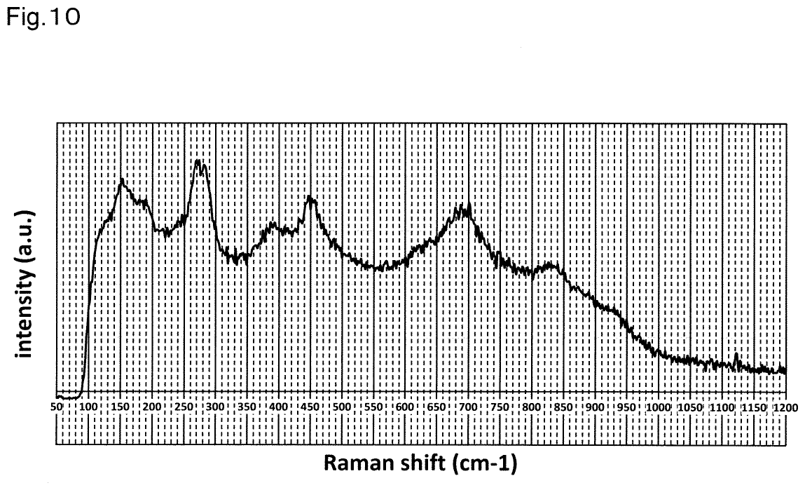

The dry powder obtained in the same manner as described above was subjected to Raman spectroscopic analysis in the same manner as in Example 1, and a Raman shift was obtained using a laser having a wavelength of 514 nm. The result is illustrated in FIG. 10. From FIG. 10, it can be seen that in the Raman spectrum using a laser with a wavelength of 514 nm, the Raman shift has peaks at positions of 150, 190, 274, 285, 395, 455, 695, and 837 cm⁻¹. Since having peaks at these positions, it is considered that the crystal structure of the obtained material is a mixture of a lepidocrocite type and an anatase type. In addition, since it has a peak at the position of 665 to 745 cm⁻¹ and the average intensity at 745 to 765 cm⁻¹ is smaller than the average intensity at 735 to 745 cm⁻¹, it is considered that the TMA cations and TMAH derived from the production step have been removed.

### (BET Specific Surface Area)

Using the dry powder obtained as described above, degassing treatment was performed in the same manner as in Example 1, and then an adsorption isotherm of nitrogen gas was measured at a liquid nitrogen temperature (77 K). As a result, the BET specific surface area (SSA) of the dry powder was 452 m²/g.

### (Pore Volume (DFT Theory))

The pore volume based on the DFT theory was calculated using the above adsorption isotherm results and found to be 0.351 cc/g.

### (Evaluation of Adsorption Performance)

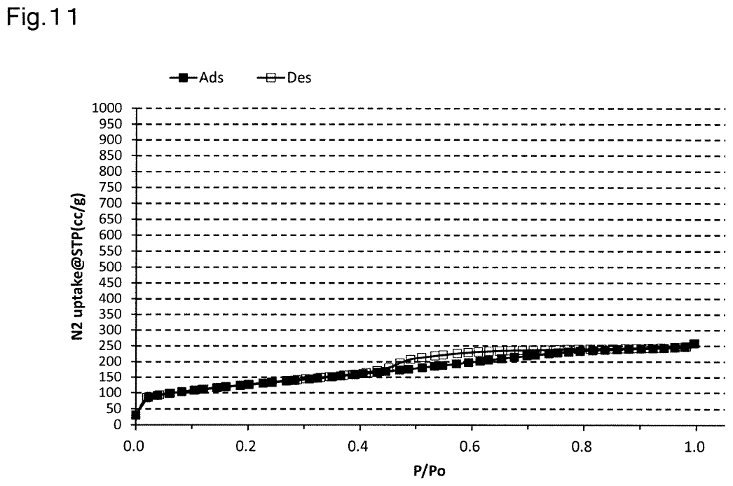

The adsorption isotherm (the description of the adsorption isotherm is the same as in Example 1) obtained by the above measurement is illustrated in FIG. 11. From the results in FIG. 11, the maximum value of the nitrogen adsorption amount was about 258 cc/g.

### Example 3

In Example 3, a dry powder was obtained in the same manner as in Example 1 except that the acid aqueous solution used for acid washing was different. Specifically, using a sample slurry obtained in the same manner as in Example 1, an acid-washed slurry was produced using a 0.05 M sulfuric acid aqueous solution instead of a 0.5 M acetic acid aqueous solution. Preparation of a dry powder using the acid-washed slurry was performed in the same manner as in Example 1.

### Analysis

### (Raman Spectroscopic Analysis)

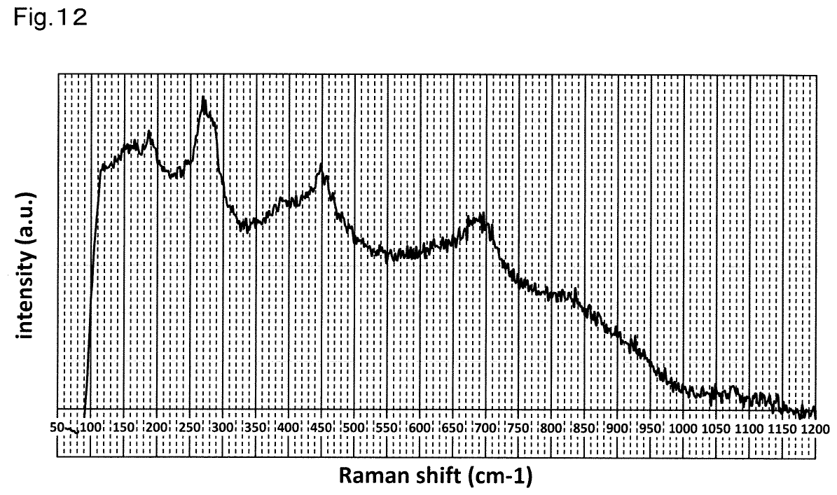

The dry powder obtained in the same manner as described above was subjected to Raman spectroscopic analysis in the same manner as in Example 1, and a Raman shift was obtained using a laser having a wavelength of 514 nm. The result is illustrated in FIG. 12. From FIG. 12, it can be seen that in the Raman spectrum using a laser with a wavelength of 514 nm, the Raman shift has peaks at positions of 185, 270, 280, 390, 450, 695, and 835 cm⁻¹. Since having peaks at these positions, it is considered that the obtained material has a lepidocrocite type crystal structure. In addition, since it has a peak at the position of 665 to 745 cm⁻¹ and the average intensity at 745 to 765 cm⁻¹ is smaller than the average intensity at 735 to 745 cm⁻¹, it is considered that the TMA cations and TMAH derived from the production step have been removed.

### (BET Specific Surface Area)

Using the dry powder obtained as described above, degassing treatment was performed in the same manner as in Example 1, and then an adsorption isotherm of nitrogen gas was measured at a liquid nitrogen temperature (77 K). As a result, the BET specific surface area (SSA) of the dry powder was 210 m²/g.

### (Pore Volume (DFT Theory))

The pore volume based on the DFT theory was calculated using the above adsorption isotherm results and found to be 0.168 cc/g.

### (Evaluation of Adsorption Performance)

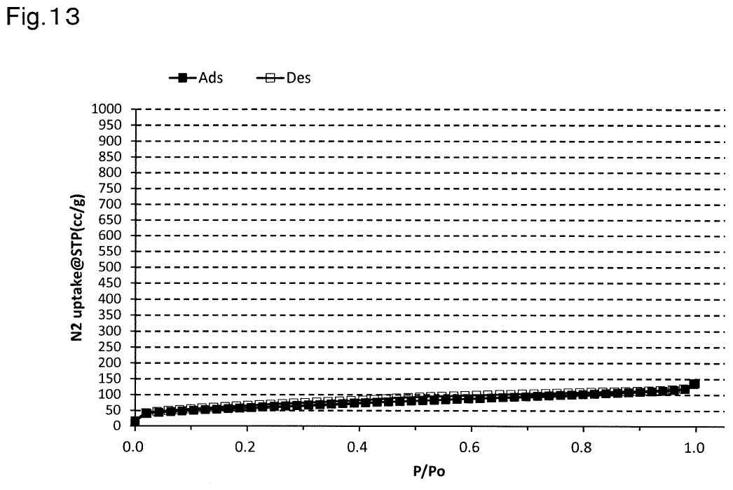

The adsorption isotherm (the description of the adsorption isotherm is the same as in Example 1) obtained by the above measurement is illustrated in FIG. 13. From the results in FIG. 13, the maximum value of the nitrogen adsorption amount was about 137 cc/g.

### Example 4

### Production of TiCO

First, a polyethylene container (250 mL Aiboy) was charged with 20 g of titanium diboride (TiB₂, −325 mesh, manufactured by Thermo Scientific) and 180 mL of a 25% by mass of tetramethylammonium hydroxide (TMAH) solution (manufactured by Alfa Aesar). The container was shaken in a constant temperature shaking incubator (211DS 49 L Shaking Incubator, Labnet International Inc., NC) set at 80° C. and 175 rpm for 4 days to allow the reaction to proceed. The reaction mixture in the container was then transferred to a centrifuge tube. The reaction mixture was allowed to settle by standing, and the supernatant was discarded to recover the solid content. (i) Ethanol (manufactured by Decon Lab, 200 proof) was added to the collected solid content, and the mixture was stirred with an overhead mixer (OSC-10L-200 rpm, LabFish, China) for 1 hour. (ii) After standing, the reaction mixture was allowed to settle by standing, and the supernatant was discarded to recover the solid content. The operations (i) to (ii) were repeated until the pH of the supernatant was 8 or less. When the procedure was repeated three times, the pH of the supernatant became 8 or less. Therefore, this supernatant was discarded, and the repeated operation was terminated. The obtained solid content dried at 50° C. overnight in an oven corresponds to TiCO (refer to the analysis results below).

### Production of LiCl-Washed TiCO

(i) In the production of TiCO, a 0.5 M LiCl (Alfa Aesar>99% purity) aqueous solution was added to the solid content before drying in a beaker, and the mixture was stirred for 6 hours. (ii) The solid content was settled by standing, and the supernatant was discarded to recover the solid content. The operations (i) to (ii) were repeated three times in total (iii) Ion-exchanged water was added to the recovered solid content, and the mixture was stirred for 1 hour. (iv) The solid content was settled by standing, and the supernatant was discarded to recover the solid content. The operations (iii) to (iv) were repeated three times in total. The obtained solid content corresponds to LiCl-washed TiCO.

### Production of Acid-Washed TiCO

The solid content obtained in the production of the LiCl-washed TiCO was immersed in a 0.1 M nitric acid aqueous solution and stirred for 1 hour. Next, (v) Ion-exchanged water was added to the recovered solid content, and the mixture was stirred for 1 hour. (vi) The solid content was settled by standing, and the supernatant was discarded to recover the solid content. The operations (v) to (vi) were repeated until the pH of the supernatant was 7 or more. The operation was performed within 1 hour from the addition of the acid aqueous solution. Finally, the supernatant was discarded to obtain a solid. The obtained solid content corresponds to acid-washed TiCO.

### Preparation of Dry Powder

The obtained acid-washed TiCO was dried in an oven at 50° C. overnight to obtain a dry powder.

### Analysis

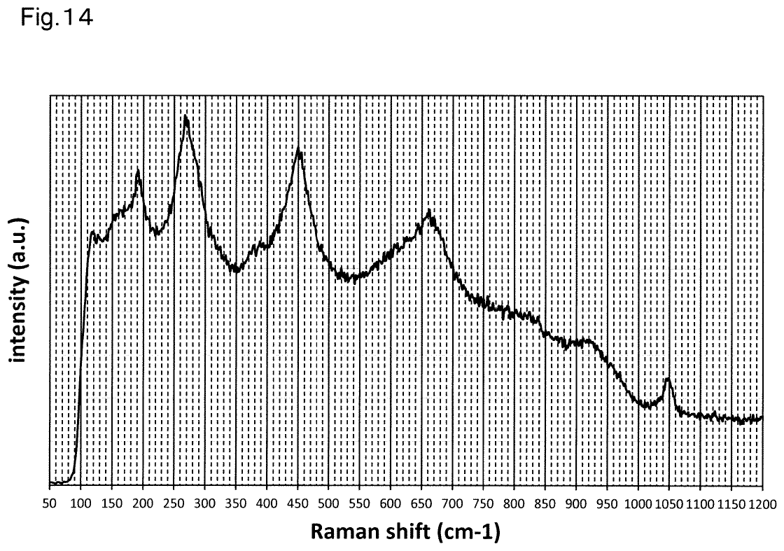

The dry powder obtained in the same manner as described above was subjected to Raman spectroscopic analysis in the same manner as in Example 1, and a Raman shift was obtained using a laser having a wavelength of 514 nm. The result is illustrated in FIG. 14. From FIG. 14, it can be seen that in the Raman spectrum using a laser with a wavelength of 514 nm, the Raman shift has peaks at positions of 190, 270, 390, 450, 660, and 840 cm⁻¹. Since having peaks at these positions, it is considered that the obtained material has a lepidocrocite type crystal structure. In addition, since it has a peak at the position of 665 to 745 cm⁻¹ and the average intensity at 745 to 765 cm⁻¹ is smaller than the average intensity at 735 to 745 cm⁻¹, it is considered that the TMA cations and TMAH derived from the production step have been removed.

### (Measurement of XRD Profile)

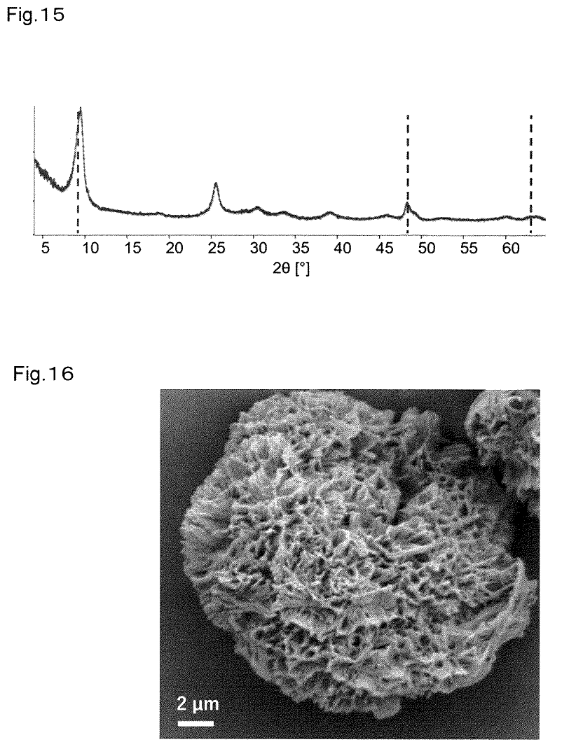

The XRD profile of the dry powder obtained in the same manner as described above was determined in the same manner as in Comparative Example 1. The obtained XRD pattern is illustrated in FIG. 15. As illustrated in FIG. 15, this material is considered to have a crystal structure of lepidocrocite because it had peaks at 2θ=26°, 2θ=48°, and 2θ=63°.

When the crystal axis was determined as illustrated in FIG. 5, peaks of the crystal plane (0k0) were confirmed at 2θ=9°, 19°, 26°, and 31°. This is because the one-dimensional nanofibers arranged in a b-axis direction become a two-dimensional sheet and are stacked in a c-axis direction. In addition, d spacing=9 angstroms obtained from 2θ=9° was smaller than that of Comparative Example 1. This is considered to be because the TMA cation present between the layers was replaced with a H₃O cation.

### (SEM Observation)

The dry powder was placed on a base, and SEM observation was performed. The SEM observation photograph is illustrated in FIG. 16. As illustrated in FIG. 16, the porous particle made of fibers was observed.

### (BET Specific Surface Area)

Using the dry powder obtained as described above, degassing treatment was performed in the same manner as in Example 1, and then an adsorption isotherm of nitrogen gas was measured at a liquid nitrogen temperature (77 K). As a result, the BET specific surface area (SSA) of the dry powder was 143 m²/g.

### (Pore Volume (DFT Theory))

The pore volume based on the DFT theory was calculated using the above adsorption isotherm results and found to be 0.240 cc/g.

### (Evaluation of Adsorption Performance)

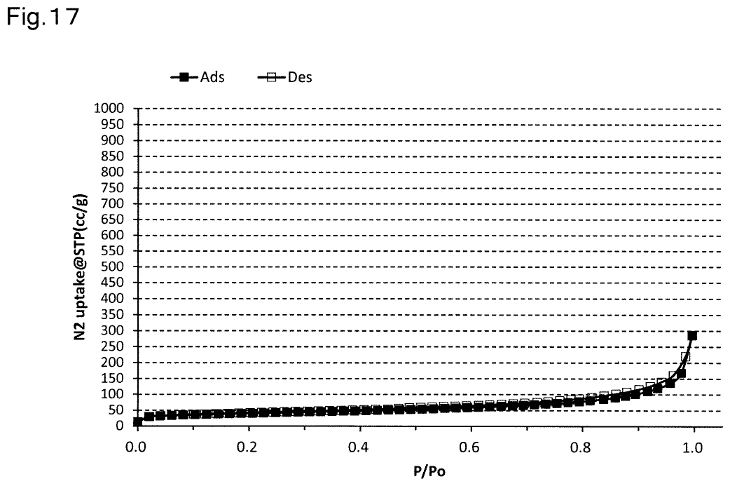

The adsorption isotherm (the description of the adsorption isotherm is the same as in Example 1) obtained by the above measurement is illustrated in FIG. 17. From the results in FIG. 17, the maximum value of the nitrogen adsorption amount was about 286 cc/g.

### Example 5

In Example 5, an acid-washed slurry was produced in the same manner as in Example 1 except that an acetic acid aqueous solution was added to the sample slurry and the time from shaking and stirring using a Vortex mixer to centrifugation was changed to two weeks (that is, centrifugation is performed after leaving to stand for 2 weeks after the shaking and stirring) in the production of the acid-washed slurry. In addition, the dry powder was prepared in the same manner as in Example 2.

### Analysis

### (Raman Spectroscopic Analysis)

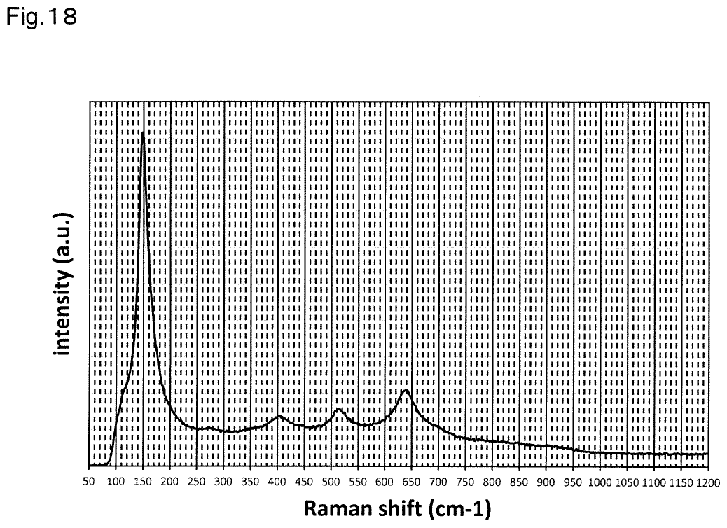

The dry powder obtained in the same manner as described above was subjected to Raman spectroscopic analysis in the same manner as in Example 1, and a Raman shift was obtained using a laser having a wavelength of 514 nm. The result is illustrated in FIG. 18. From FIG. 18, since the Raman shift had peaks at positions of 150, 405, 515, and 640 cm⁻¹ in the Raman spectrum using a laser with a wavelength of 514 nm, it is considered to have an anatase type crystal structure. In addition, since it has a peak at the position of 630 to 650 cm⁻¹ and the average intensity at 745 to 765 cm⁻¹ is smaller than the average intensity at 735 to 745 cm⁻¹, it is considered that the TMA cations and TMAH derived from the production step have been removed.

### (Measurement of XRD Profile)

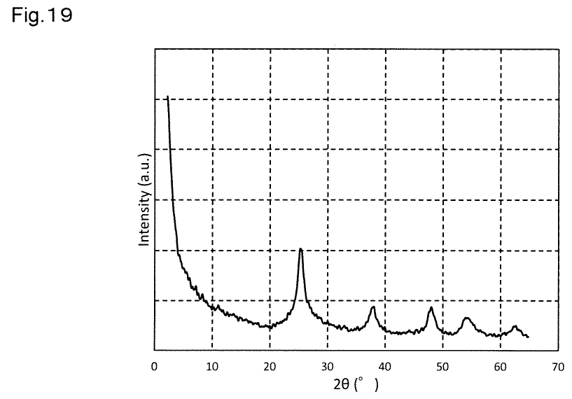

The XRD profile of the dry powder obtained in the same manner as described above was determined in the same manner as in Comparative Example 1. The obtained XRD pattern is illustrated in FIG. 19. As illustrated in FIG. 19, this material has peaks at 2θ=26° and 2θ=38°, 2θ=48°, 2θ=54°, and 2θ=63°. Since it has peaks at these positions, it is considered to have an anatase type crystal structure.

### (TEM Observation)

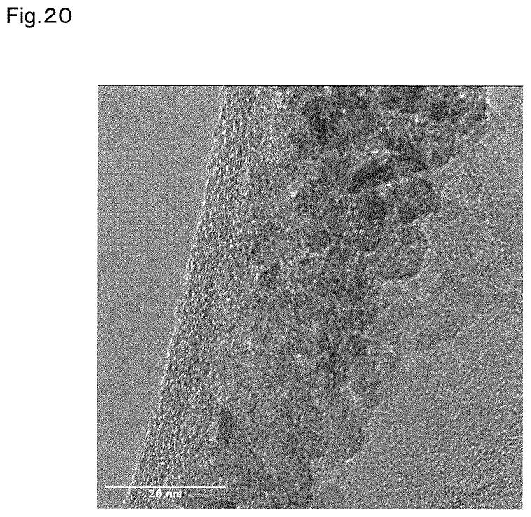

The produced acid-washed slurry was diluted 500 times, dropped on a TEM grid, and dried overnight in an air atmosphere. Then, TEM observation was performed. The TEM observation photograph is illustrated in FIG. 20. From FIG. 20, an amorphous part and particles of around 10 nm were observed. In addition, since lattice lines are observed in some of the particles, it is considered that there is also a crystalline part.

### (BET Specific Surface Area)

Using the dry powder obtained as described above, degassing treatment was performed in the same manner as in Example 1, and then an adsorption isotherm of nitrogen gas was measured at a liquid nitrogen temperature (77 K). As a result, the BET specific surface area (SSA) of the dry powder was 370 m²/g.

### (Pore Volume (DFT Theory))

The pore volume based on the DFT theory was calculated using the above adsorption isotherm results and found to be 0.268 cc/g.

### (Evaluation of Adsorption Performance)

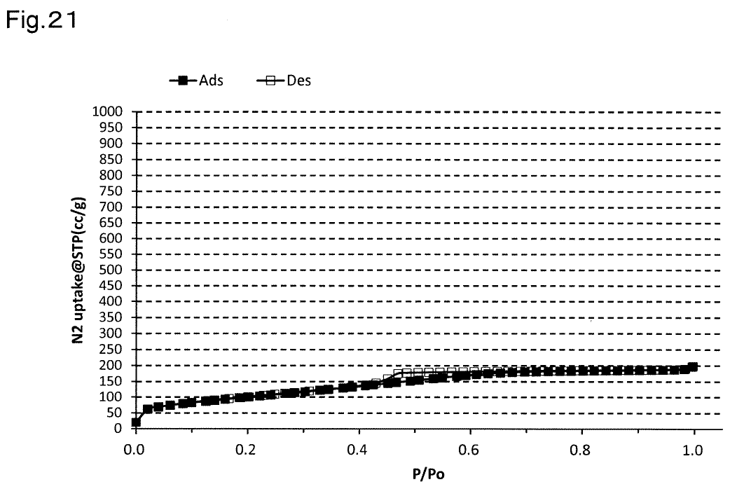

The adsorption isotherm (the description of the adsorption isotherm is the same as in Example 1) obtained by the above measurement is illustrated in FIG. 21. From the results in FIG. 21, the maximum value of the nitrogen adsorption amount was about 198 cc/g.

### Example 6

In Example 6, an acid-washed slurry was obtained in the same manner as in Example 5 except that the acid aqueous solution used for acid washing was different. Specifically, using a sample slurry obtained in the same manner as in Example 1, an acid-washed slurry was produced using a 0.05 M sulfuric acid aqueous solution instead of a 0.5 M acetic acid aqueous solution. Preparation of a dry powder using the acid-washed slurry was performed in the same manner as in Example 2.

### Analysis

### (Raman Spectroscopic Analysis)

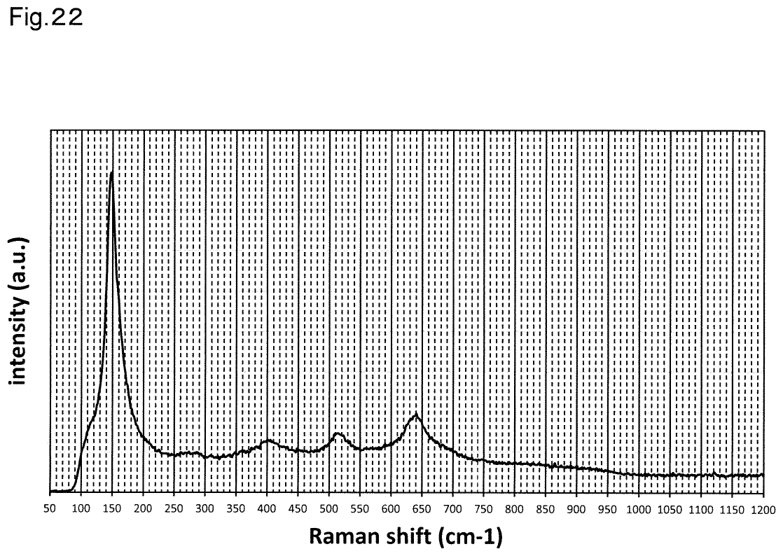

The dry powder obtained in the same manner as described above was subjected to Raman spectroscopic analysis in the same manner as in Example 1, and a Raman shift was obtained using a laser having a wavelength of 514 nm. The result is illustrated in FIG. 22. From FIG. 22, since the Raman shift had peaks at positions of 150, 400, 515, and 640 cm⁻¹ in the Raman spectrum using a laser with a wavelength of 514 nm, it is considered to have an anatase type crystal structure. In addition, since it has a peak at the position of 630 to 650 cm⁻¹ and the average intensity at 745 to 765 cm⁻¹ is smaller than the average intensity at 735 to 745 cm⁻¹, it is considered that the TMA cations and TMAH derived from the production step have been removed.

### (Measurement of XRD Profile)

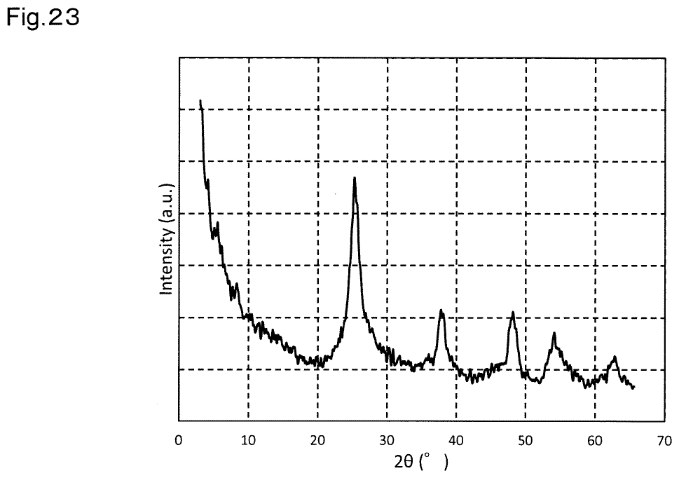

The XRD profile of the dry powder obtained in the same manner as described above was determined in the same manner as in Comparative Example 1. The obtained XRD pattern is illustrated in FIG. 23. As illustrated in FIG. 23, this material is considered to have an anatase type crystal structure because it had peaks at 2θ=26°, 2θ=38°, 2θ=48°, 2θ=54°, and 2θ=63°.

### (BET Specific Surface Area)

Using the dry powder obtained as described above, degassing treatment was performed in the same manner as in Example 1, and then an adsorption isotherm of nitrogen gas was measured at a liquid nitrogen temperature (77 K). As a result, the BET specific surface area (SSA) of the dry powder was 388 m²/g.

### (Pore Volume (DFT Theory))

The pore volume based on the DFT theory was calculated using the above adsorption isotherm results and found to be 0.291 cc/g.

### (Evaluation of Adsorption Performance)

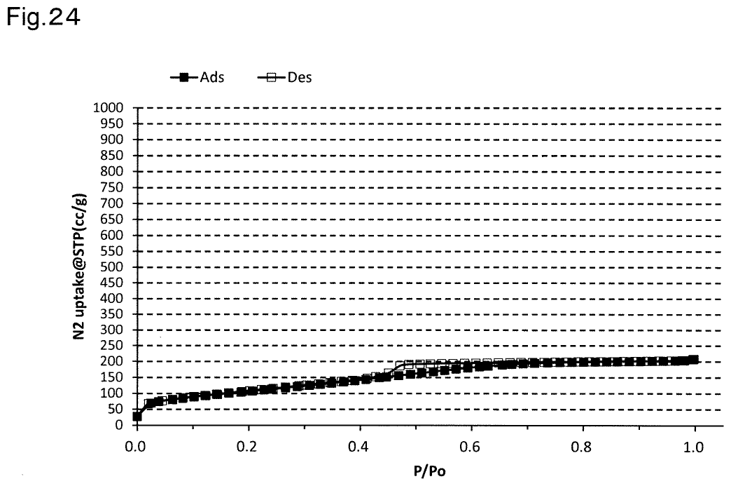

The adsorption isotherm (the description of the adsorption isotherm is the same as in Example 1) obtained by the above measurement is illustrated in FIG. 24. From the results in FIG. 24, the maximum value of the nitrogen adsorption amount was about 208 cc/g.

### Example 7

In Example 7, a filtration membrane was prepared. Specifically, up to the preparation of the acid-washed slurry was performed in the same manner as in Example 1. Thereafter, a dry powder was prepared in the same manner as in Example 2. Using the obtained dry powder, a filtration membrane was prepared as follows.

### Preparation of Filtration Membrane

The filter membrane obtained by performing suction filtration in the same manner as in the preparation of the dry powder of Example 2 was immersed in a 0.5 M acetic acid aqueous solution overnight. Thereafter, the filtration membrane was repeatedly washed with ion-exchanged water until the pH of the washing liquid reached 8 or less. Finally, the washing liquid was discarded, the filtration membrane was recovered, and washing was completed. Subsequently, the filtration membrane was dried in an oven at 50° C. overnight, and the filter was removed to obtain a filtration membrane.

### Analysis

### (Raman Spectroscopic Analysis)

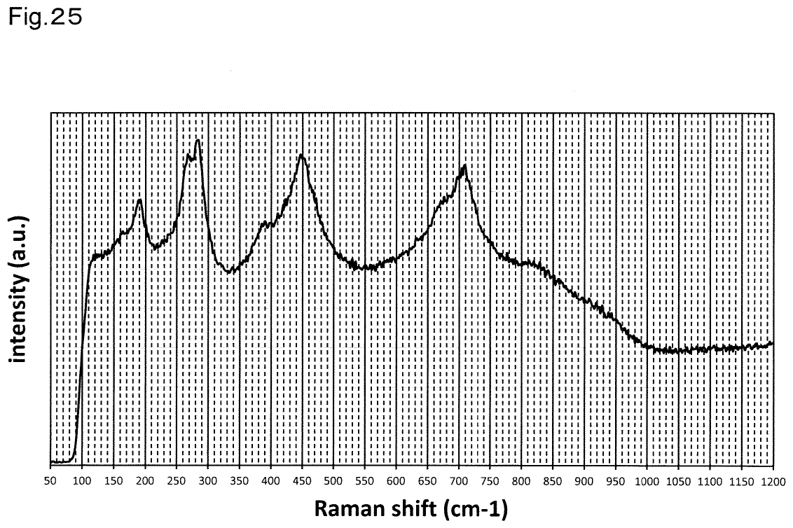

The dry powder obtained in the same manner as described above was subjected to Raman spectroscopic analysis in the same manner as in Example 1, and a Raman shift was obtained using a laser having a wavelength of 514 nm. The result is illustrated in FIG. 25. From FIG. 25, it can be seen that in the Raman spectrum using a laser with a wavelength of 514 nm, the Raman shift has peaks at positions of 190, 270, 285, 390, 450, and 710 cm⁻¹. Since having peaks at these positions, it is considered that the obtained material has a lepidocrocite type crystal structure. In addition, since it has a peak at the position of 665 to 745 cm⁻¹ and the average intensity at 745 to 765 cm⁻¹ is smaller than the average intensity at 735 to 745 cm⁻¹, it is considered that the TMA cations and TMAH derived from the production step have been removed.

In Examples 2 to 6, as in Example 1, the TMA cations and TMAH derived from the production step were removed, and the nitrogen adsorption amount was higher than that in Comparative Examples 1 and 2. Also in Example 7, the nitrogen adsorption amount of the filter membrane obtained in Example 7 is considered to be higher than those in Comparative Examples 1 and 2, and it is considered that a membrane having high adsorption performance is obtained.

In the present example, since the oxide material according to the present embodiment exhibited high adsorption performance with respect to nitrogen, it is considered that the oxide material exhibits high adsorption performance with respect to other gases such as hydrogen, carbon dioxide, methane, krypton, and argon.

The oxide material of the present disclosure can be utilized in a wide variety of applications, for example, but not limited to, adsorption of gases (more particularly, one or more gases selected from the group consisting of hydrogen, carbon dioxide, methane, nitrogen, krypton, and argon). The oxide material of the present disclosure can be used in slurries, films, gas adsorption apparatuses (more specifically, an adsorption apparatus for one or more gases selected from the group consisting of hydrogen, carbon dioxide, methane, nitrogen, krypton, and argon), and the like.

1. An oxide material comprising:
one or more selected from the group consisting of a nanofiber, a two-dimensional substance, or an amorphous substance of a material represented by: 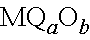
wherein M is one or more elements selected from the group consisting of Groups 3, 4, 5, 6, and 7,
Q is one or more elements selected from the group consisting of Groups 12, 13, 14, 15, and 16, and excluding O,
a is 0 to 2, and
b is more than 0 and 2 or less,
wherein in a Raman spectrum, an average intensity of the oxide material at 745 to 765 cm⁻¹ is smaller than an average intensity at 735 to 745 cm⁻¹, and
wherein a pore volume of the oxide material is 0.060 cc/g or more.

2. The oxide material according to claim 1, wherein the pore volume is 0.150 cc/g or more and/or a BET specific surface area of the oxide material is 130 m²/g or more.

3. The oxide material according to claim 1, wherein the pore volume is 0.150 cc/g or more.

4. The oxide material according to claim 1, wherein a BET specific surface area of the oxide material is 130 m²/g or more.

5. The oxide material according to claim 1, wherein a BET specific surface area of the oxide material is 130 m²/g to 800 m²/g.

6. The oxide material according to claim 1, wherein the oxide material has a crystal structure of an anatase type, a lepidocrocite type, or a mixture thereof.

7. The oxide material according to claim 1, further comprising a nanoparticle of the material.

8. The oxide material according to claim 1, wherein the oxide material is a porous particle made of the nanofiber.

9. The oxide material according to claim 1, of which a surface is protonated.

10. The oxide material according to claim 1, which does not contain metal ions other than Ti.

11. The oxide material according to claim 1, wherein the a is more than 0.

12. The oxide material according to claim 1, wherein the Q is C.

13. A method for producing an oxide material, the method comprising:
(a) preparing a precursor material represented by the following formula: 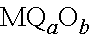
wherein M is one or more elements selected from the group consisting of Groups 3, 4, 5, 6, and 7,
Q is one or more elements selected from the group consisting of Groups 12, 13, 14, 15, and 16, and excluding O,
a is 0 to 2, and
b is more than 0 and 2 or less; and
(b) performing acid washing of the precursor material using an acid aqueous solution, and then performing water washing.

14. The method according to claim 13, wherein the acid washing of the precursor material is performed by bringing an aqueous dispersion of the precursor material into contact with the acid aqueous solution.

15. The method according to claim 13, wherein the acid washing of the precursor material is performed by bringing a solid form of the precursor material into contact with the acid aqueous solution.

16. The method according to claim 13, wherein the a is more than 0.

17. The method according to claim 13, wherein the Q is C.

18. The method according to claim 13, wherein in a Raman spectrum, an average intensity of the precursor material at 745 to 765 cm⁻¹ is smaller than an average intensity at 735 to 745 cm⁻¹.

19. The method according to claim 13, wherein a pore volume of the precursor material is 0.060 cc/g or more.
